(19) United States
(12) Patent Application Publication
(10) Pub. No.: US 2010/0252586 A1
(43) Pub. Date: Oct. 7, 2010

(54) POWDER DISPENSING CONTAINER

(75) Inventors: Greg Jimenez, Hoffman Estates, IL (US); Phil D'Andrea, Williamsville, NY (US)

Correspondence Address: HUSCH BLACKWELL SANDERS LLP, 190 Carondelet Plaza, Suite 600, ST. LOUIS, MO, 63105, US

(73) Assignee: KRANSON INDUSTRIES, INC. D/B/A TRICORBRAUN, St. Louis, MO (US)

(21) Appl. No.: 12/748,993

(22) Filed: Mar. 29, 2010

Related U.S. Application Data
(60) Provisional application No. 61/165,807, filed on Apr. 1, 2009.

(51) Int. Cl. B67D 3/00; A47G 19/24

(52) U.S. Cl. 222/480; 222/565

(57) ABSTRACT

An improved dispensing closure for a powder container includes a first portion having first engagement means and at least a first dispensing outlet in said first bottom surface; a second portion having second engagement means wherein the first and second engagement cooperate to rotationally engage the first and second portions, and at least a second dispensing outlet which is at least as large as the first dispensing outlet; and a tamper evident tab removably attached to the second portion and positioned adjacent the second dispensing outlet.

### CROSS REFERENCE

This application claims the priority of co-pending provisional application Ser. No. 61/165,807, filed Apr. 1, 2009.

### TECHNICAL FIELD OF THE INVENTION

This invention relates generally to the field of molded packaging and, more particularly, to an improved container designed for controlling dispensing of powdered materials.

### SUMMARY OF THE INVENTION

One aspect of the invention generally pertains to an improved container for a container for loose powder and similar materials.

Another aspect of the invention pertains to an improved closure for a powder container providing a tamper-evident indicator integrated therein.

Yet another aspect of the invention pertains to an improved container for powder-type materials with an improved selectively closable sifting mechanism.

In accordance with the above aspects of the invention, there is provided an improved dispensing closure for a powder container including a first portion having first engagement means and at least a first dispensing outlet in said first bottom surface; a second portion having second engagement means wherein the first and second engagement cooperate to rotationally engage the first and second portions, and at least a second dispensing outlet which is at least as large as the first dispensing outlet; and a tamper evident tab removably attached to the second portion and positioned adjacent the second dispensing outlet.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an exploded view of a container for powdered materials incorporating a closure according to a first embodiment of the present invention.

FIG. 2 is a top view of a first portion of the closure of FIG. 1.

FIG. 3 is a first cross-sectional view of the first portion of FIG. 2 taken along the line 3-3 in FIG. 2.

FIG. 4 is a second cross-sectional view of the first portion of FIG. 2 taken along the line 4-4 in FIG. 2.

FIG. 5 is a top view of a second portion of the closure of FIG. 1.

FIG. 6 is a cross-sectional view of the first portion of FIG. 5 taken along the line 5-5 in FIG. 5.

FIG. 7 is a cross-sectional view of the first portion of FIG. 5 taken along the line 7-7 in FIG. 5.

FIG. 8 is a top view of a tamper-evident tab of the closure of FIG. 1.

FIG. 9 is a bottom view of the tamper-evident tab of FIG. 1.

FIG. 10 is a side view of the tamper-evident tab of FIG. 1.

FIG. 11 is a top view of the container of FIG. 1 with a tamper-evident tab in place and the over cap removed.

FIG. 12 is a top view of a container body of the container in FIG. 1.

FIG. 13 is a cross-sectional view of the container body of the container of FIG. 12.

FIG. 14 is an isometric view of an over cap of the container in FIG. 1.

FIG. 15 is a cross-sectional view of the over cap of FIG. 14.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

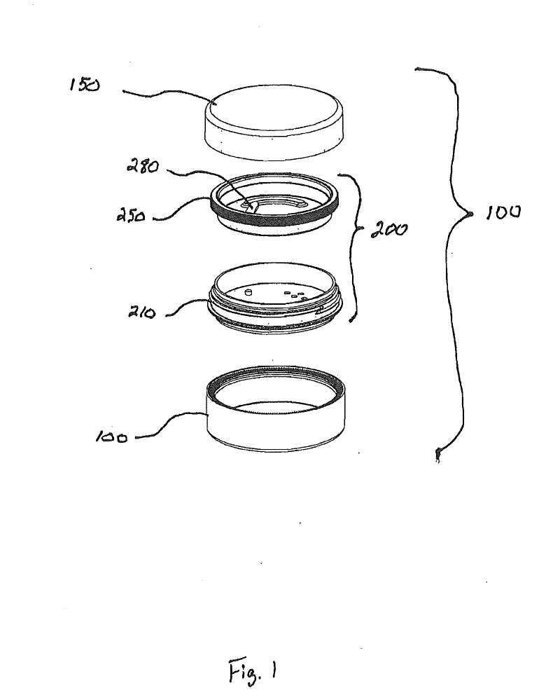

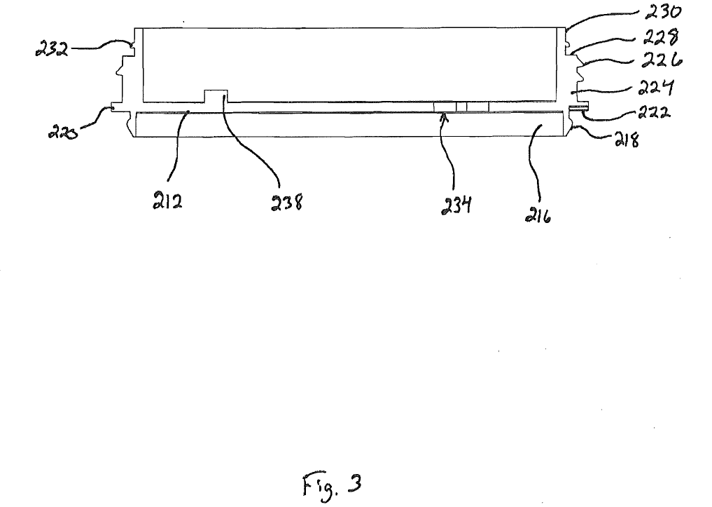

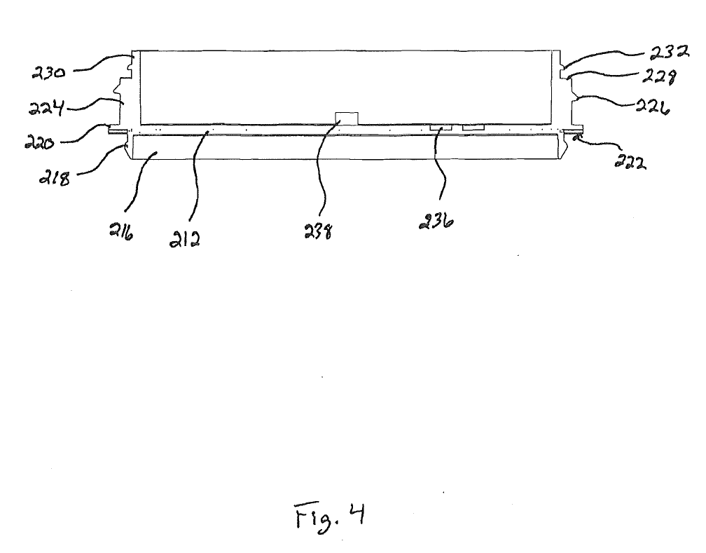

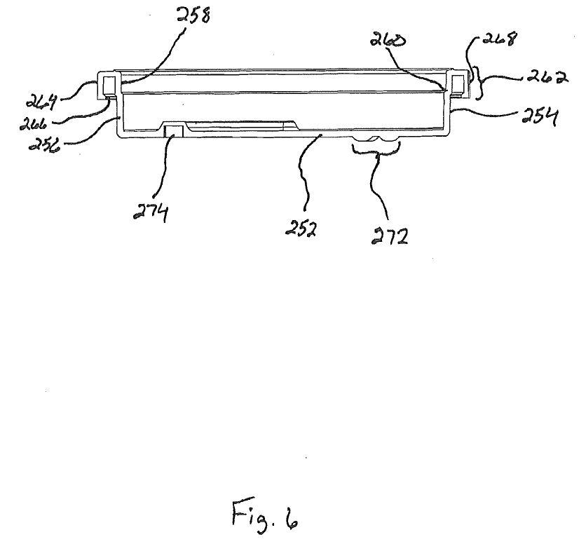

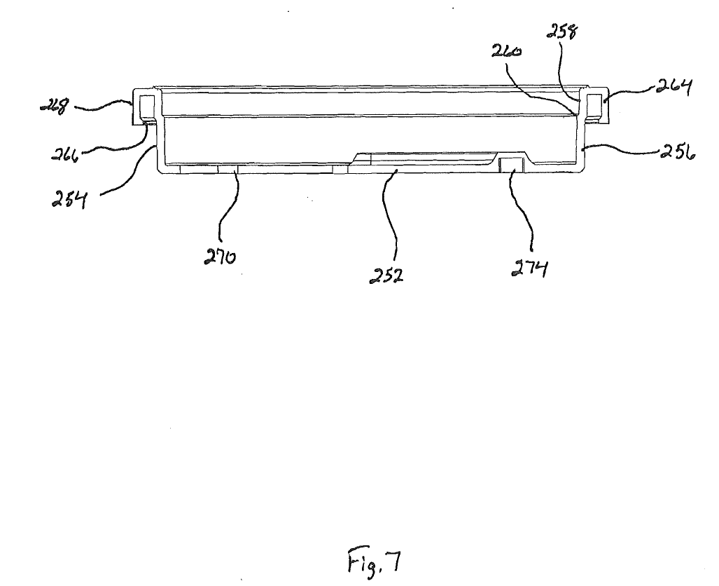

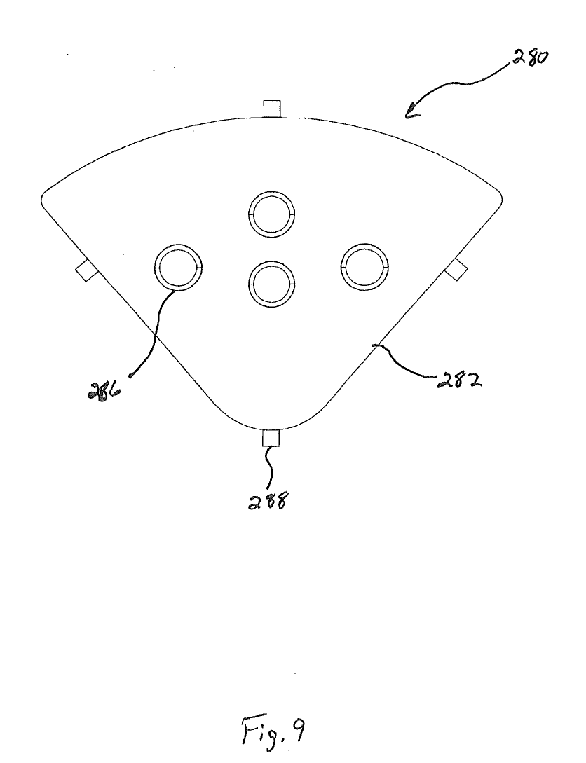

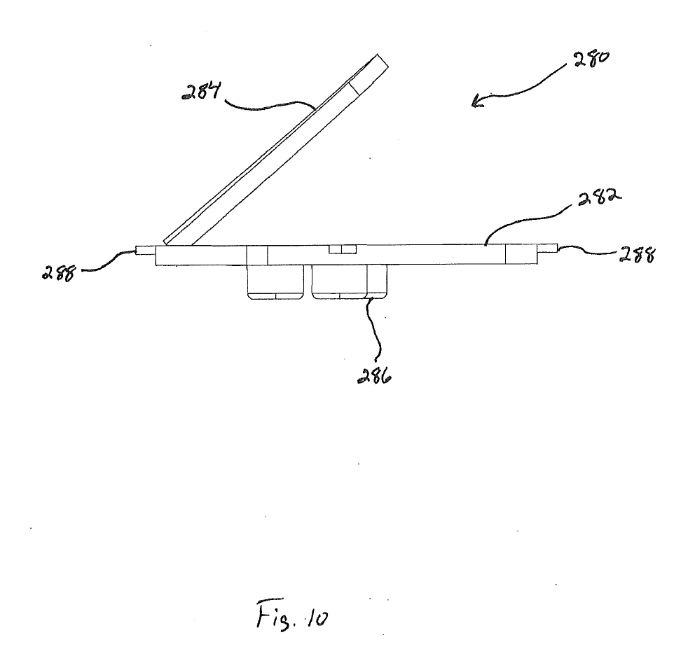

FIGS. 1-15 illustrate an embodiment of a container 100 utilizing an improved powder dispensing closure 200 according to one embodiment of the present invention. The container 100 also includes a container body 110 and an over cap 150. The container body 110 and over cap 150 can be manufactured from any suitable materials and can take on various sizes and forms. However, for the purposes of the preferred embodiments, the container body 110 and over cap 150 are provided with a circular cross-section.

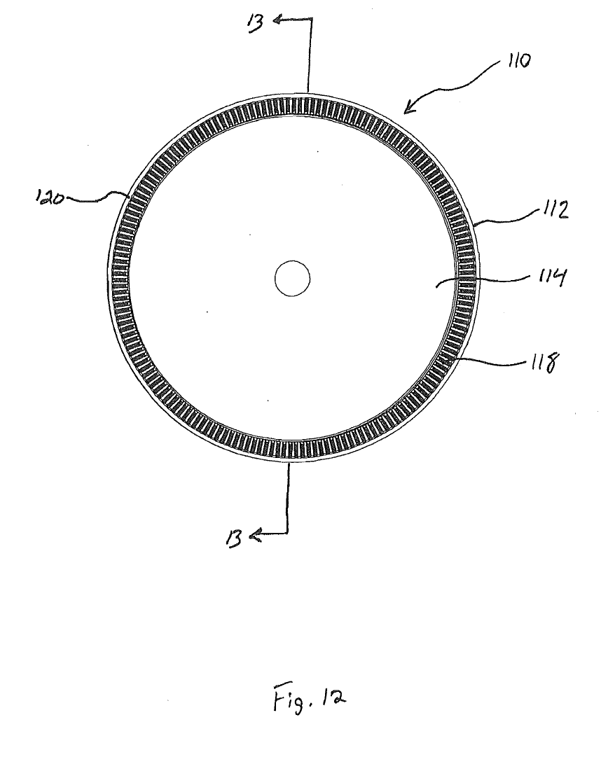

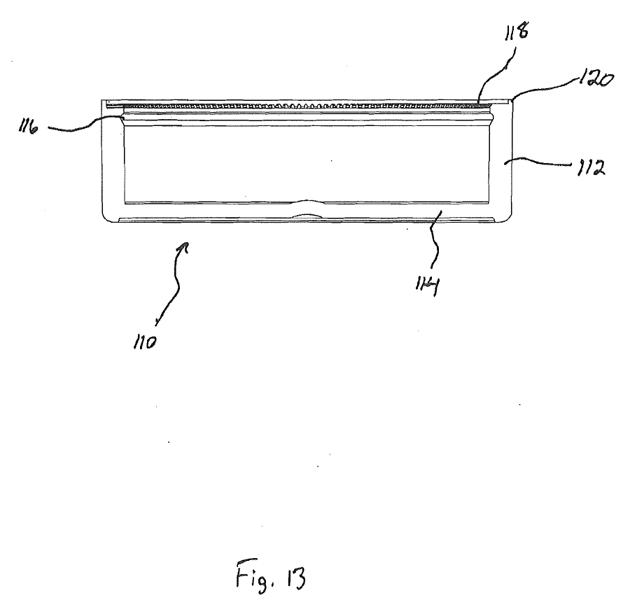

As shown most clearly in FIGS. 12 and 13, the container body 110, in particular, is provided with a circular side wall 112 extending upwardly from a bottom surface 114. In a preferred embodiment, the side wall 112 is provided with a relatively significant thickness, on the order of 3 mm, in order to provide suitable rigidity to the container body 110 and sufficient working room to incorporate the additional features described below.

Adjacent the upper end of the side wall 112 and along the interior thereof is a mating groove 116. The groove 116 is arranged to mate with an external lip 218 of a first portion 210 of the dispensing closure 200, as will be described in more detail below. The upper end of the side wall 112 terminates in a bi-level manner. At a lower level of the upper end of the side 112, there is provided an upward facing ridged surface 118. This ridged surface 118 is arranged to advantageously interact with a similar ridged surface on the dispensing closure 200, as will described in more detail below. Positioned along the outside perimeter of the ridged surface 118 is an upwardly extending lip 120. Preferably, the outer surface of the side wall extends smoothly up to the top of the upwardly extending lip 120, thereby presenting a smooth and uniform appearance when the container 100 is fully assembled.

As shown in FIGS. 1-7, the closure 200 is primarily comprised of two pieces: a first portion 210 and a second portion 250. The first 210 and second 250 portions are advantageously arranged to mate with one another in a manner that permits rotational movement of the second portion 250 relative to the first 210. Further, this relative movement is accomplished without movement of the first portion 210 relative to the container body 110.

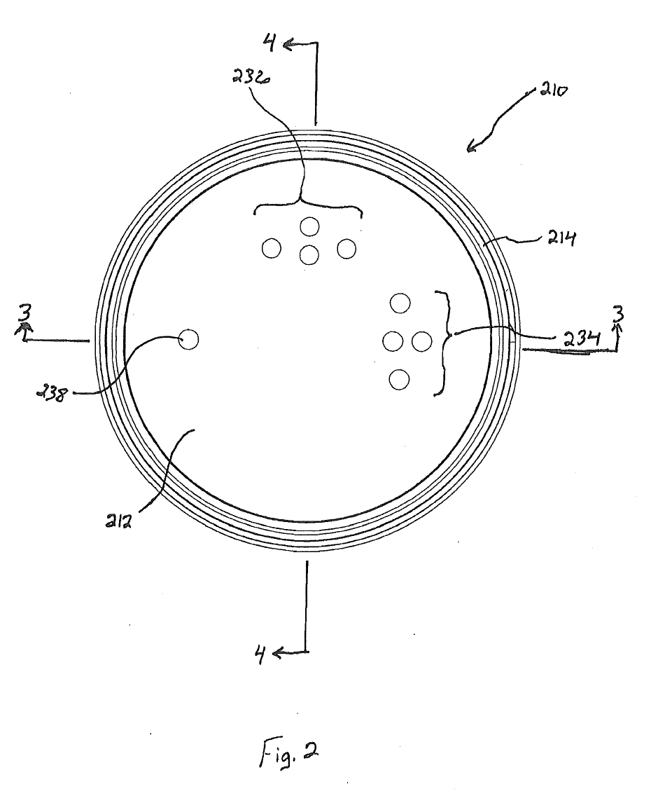

The first portion 210 of the closure 200 is illustrated in FIGS. 2-4 and includes a bottom surface 212 and a continuous circular side wall 214. The side wall 214 is provided with a downwardly extending rim 216. This rim 216 extends the side wall 214 slightly lower than the bottom surface 212 of the first portion 210. A lower external lip 218 is provided along the outside of the downward rim 216. As briefly referenced above, this lower external lip 218 engages the groove 116 of the container body to secure the first portion 210 of the closure 200 to the container body 110. For this purpose, the outer diameter of the downward rim 216 is slightly less than the inner diameter of the side wall 112 of the container body 110 to allow the first portion to descend into the container body 110 until the lower external lip 218 fully engages with and seats in the groove 116.

The first portion 210 of the closure 200 also includes an outwardly extending flange 220. A downward-facing ridged surface 222 is provided on the underside of the flange 220. The outer diameter of the flange 220 is at least greater than the inner diameter of the side wall 112 of the container body. However, in a preferred embodiment, the outer diameter of the flange 220 is also less than the inner diameter of the upwardly extending lip 120 of the container body 112. This arrangement advantageously results in the resting within the confines of the lip 120 when the first portion 210 of the closure is fully engaged with the container body 110 to help maintain a smooth and consistent exterior appearance. As the lip 218 and groove 116 engage as discussed above, the upward-facing ridged surface 118 of the container body 110 and the downwardly-facing ridged surface 222 of the first portion 210 of the closure 200 engage one another and prevent relative movement of these two pieces. In a further advantageous embodiment, the vertical distance from the bottom of downward-facing ridged surface 222 to the upper surface of the flange 220 on the first portion is approximately equal to the distance from the top of the upwardly-facing ridged surface 118 to the top of the upwardly extending lip 120 of the container body. This arrangement results in the top surfaces of the lip 120 and flange 220 being relatively flush with one another and, again, improving the aesthetic appearance of the overall container.

Above the flange 220 is a thread wall 224 portion of side wall 214. The thread wall portion 224 includes an external thread 226 which is adapted to engage the internal thread 156 of the over cap 150, described below. At the top of the thread wall portion 224, an upper wall portion 230 extends upwardly therefrom. The upper wall portion 230 is preferably provided with an outer diameter that is less than that of thread wall portion 224, thus creating a shoulder 228 therebetween. Around the periphery of the upper portion 230, an upper, external lip 232 extends outwardly. The external lip 232 facilitates engagement of the first portion 210 of the closure 200 with the second portion 250.

The bottom surface 212 of the first portion 210 includes at least one, and preferably several, sifting holes 234 extending through the bottom surface 212 in a pattern. The sifting holes 234 allow powder to pass through the first portion 212 from the container body 110. The bottom surface 212 also includes at least one detent 236 in the upper surface thereof. Advantageously, the detent(s) 236 are the same in number in pattern as the sifting holes 234. Further, the matching pattern of detents 236 are essentially displaced from the pattern of sifting holes 234 by an angle α measured about the center of the bottom surface 212, the significance which will be described below. In the embodiment illustrated in FIGS. 1-15, angle α is 90°. Finally, the bottom surface 212 includes a guide protrusion 238 extending upwardly from the top thereof. The guide protrusion is further displaced from the pattern of ball detents 236 by an angle β measured about the center of the bottom surface 212. Angle β should be equal to angle α. In the illustrated embodiment, angle β is 90°. Therefore, the guide protrusion of the illustrated embodiment is positioned 180° from the pattern of sifting holes 234 in the bottom surface 212.

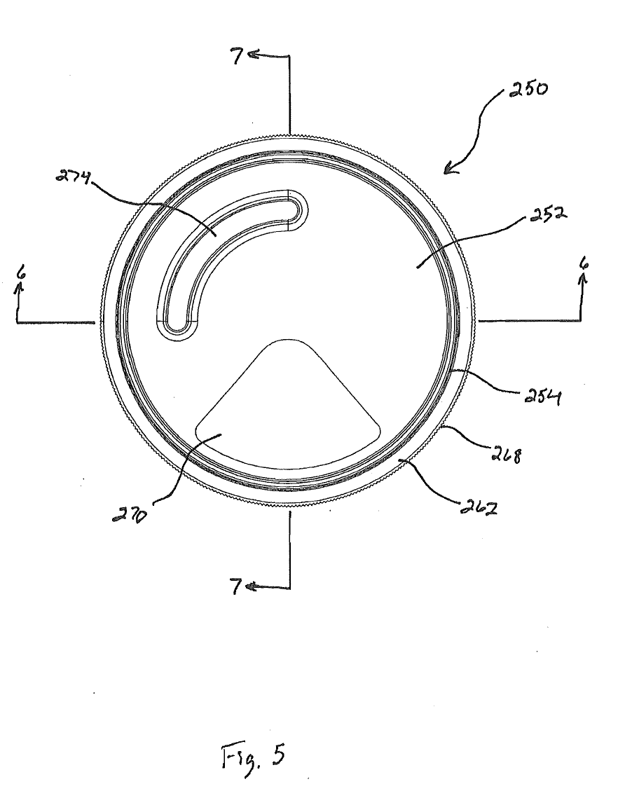

The second portion 250 of the closure 200 is illustrated in FIGS. 5-7 and also encompasses a bottom surface 252 and a circular side wall 254. The side wall 254 includes a lower portion 256 and an upper portion 258. In the illustrated embodiment, the upper portion 258 is slightly wider than the lower portion 256 creating a step 260 between the two. The upper portion 258 also has a downwardly facing collar 262 extending around the periphery thereof. The outer rim 264 of the collar 262 incorporates a lip 266 on its internal side. The external side of the outer rim 264 is provided with a textured surface 268 intended to enhance a user's ability to grip the collar to rotate the second portion 250 of the closure 200 relative to the first portion 210 when the two are mated.

The bottom surface 252 of the second portion 250 is provided with a dispensing outlet 270. In the preferred embodiment, the dispensing outlet 270 is in the general shape of a partial section of a circle. The total area of the dispensing outlet 270 is preferably sufficient to fully encompass the pattern of sifting holes 234 in the first portion 210 of the closure 200. The under side of the bottom surface 252 is provided with at least one ball protrusion 272. The ball protrusion(s) are the same in number and pattern as those of the sifting holes 234 and detents 236 and are displaced from the dispensing outlet 270 by an angle θ measured about the center of the bottom surface 252. Angle θ is preferably equal to angles α and β. In the illustrated embodiment, θ is 90°.

The bottom surface 252 also includes a semi-circular guide track 274 in the form of a depression in the bottom surface. The guide track 274 traverses an angle τ equal to angles α, β, and θ—in the illustrated case 90°. The beginning of the guide track 274 is positioned 180° from the dispensing outlet 270, while the end of the guide track 274 is positioned 180° from ball protrusions 272.

The first 210 and second 250 portions are engaged by guiding the collar 262 of the second portion 250 over the upper wall portion 230 of the first portion 210 and pushing the collar 262 down onto the upper wall portion 230 until the upper external lip 232 of the first portion 210 engages the internal lip 266 of the second portion 210. Additional force may be required to snap the internal lip 266 past the external lip 232 to fully seat and engage the two portions 210, 250. Once the two portions 21, 250 are fully seated, this arrangement allows the two pieces to move relative to one another. Again, however, as referenced above, the first portion 210 of the closure 200 is prohibited from movement relative to the container body 110 by means of the two, facing ridged surfaces 118, 222 on the container body 110 and first portion 210.

It will readily be appreciated that the various features of the bottom surfaces, 212, 252 of the first and second portions interact with one another as the second portion 250 is rotated relative to the first portion 210. In particular, this movement and related interaction of features is controlled by the engagement of the guide protrusion 238 with the guide track 274. More specifically, movement of the guide protrusion 238 with the guide track 274, and, consequently, movement of the first portion 210 relative to the second portion 250, is limited to a certain number of degrees. In the preferred embodiment, the angle of movement of the guide protrusion within the guide track is equal to angle τ, which in the illustrated case is 90°. When the guide protrusion 238 is at one end of the guide track 274, the dispensing outlet 270 is positioned directly over the patter of sifting holes 234 to allow powder to be dispensed from the container body 110. When the second portion 250 of the closure is rotated, the dispensing outlet 270 is moved to a position in which it rests over a solid portion of the bottom surface 212 of the first portion 210. In this position, the ball protrusions 272 are moved into alignment with the sifting holes 234, thereby substantially sealing same to prevent loose powder from escaping the container body 110. The end effect of this arrangement is that the closure 200, by virtue of the controlled rotation of the second portion 250 relative to the first portion 210, has positive open and closed positions. In each of these two positions, the combination of the ball protrusions 272 with either the detents 236 or the sifting holes 234 retains the second portion 250 of the closure in that position relative to the first portion 210 until a user applies sufficient rotational force to remove the ball protrusions 272 from the detents 236 or sifting holes 234, respectively, an allow rotation of the first portion 250.

It should be noted that the side walls 214, 254 of the first 210 and second 250 portions, respectively, are provided with dimensions that allow the ball protrusions 272 to engage the top of the bottom surface 212 of the first portion and, more specifically, the detents 236 and sifting holes 234 as the second portion 250 is rotated.

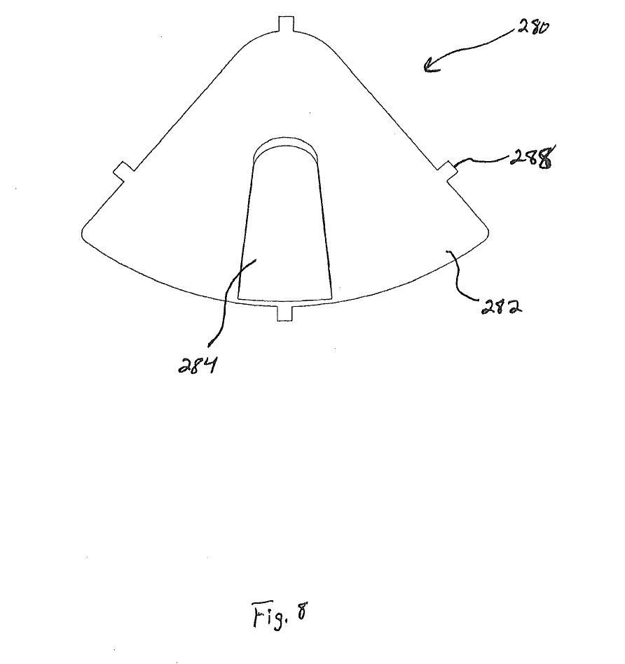

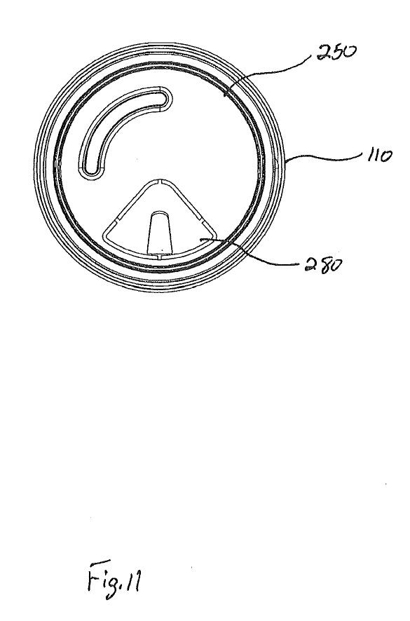

Advantageously, the closure 200 is also provided with a tamper-evident tab 280, an embodiment of which is represented in FIGS. 8-10. The tamper-evident tab 280 is generally molded initially as part of the second portion 250 of the closure within the space that also represents the dispensing outlet 270. Thus, the tab 280 is generally co-planar with the bottom surface 252 of the second portion 250. Therefore, the body 282 of the tamper-evident tab 280 will have a perimeter shape that roughly matches that of the dispensing outlet 270, as is most clearly shown in FIG. 11. However, to facilitate removal of the tab 280, the body 282 is connected with the remainder of the second portion 250 of the closure 200 by narrow bands of material flashing 288. In the illustrated embodiment, there are four such bands 288. These bands 288 are preferably of sufficiently narrowed dimension to allow a user of average strength and dexterity to remove the tab 280 completely and to destroy the bands 288 in the process, thereby preventing reattachment of the tab 280 after initial removal. The nature of the tab 280 that results in the inability to replace it after initial removal is intended to provide evidence that container 100 has been previously opened—and potentially tampered with.

The tab 280 is provided with a handle 284 to further facilitate removal by providing a ready grip for a user. Further, a series of ball protrusions 286 that match in number and pattern the sifting holes 234 is provided on the underside of the body 282 of the tab 280. These ball protrusions 286 engage and are seated in the sifting holes 234 when the first 210 and second 250 portions are initially assembled together to seal the holes 234 until the container is purchased and the user desires to use the product within.

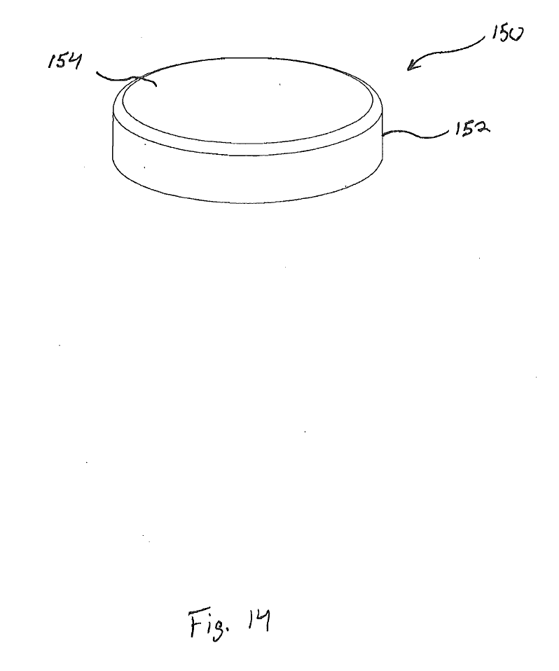

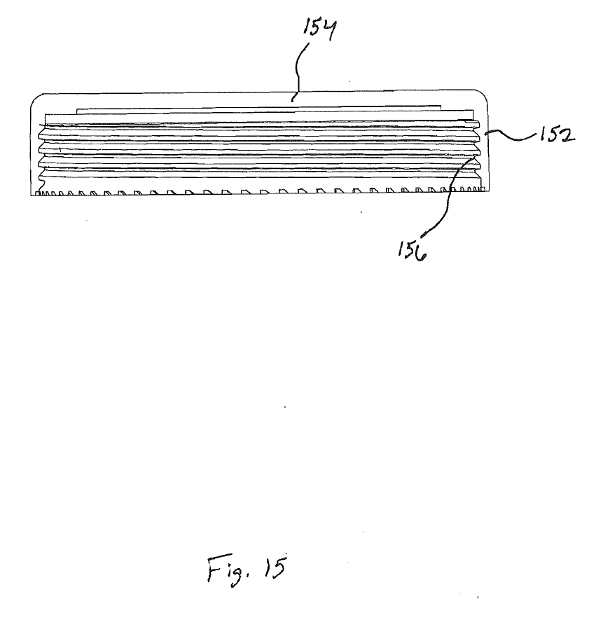

The final step in manufacture of the container 100 is to apply the over cap 150, shown in FIGS. 14 and 15. The over cap is provided with circular side wall 152 emanating downwardly from a top surface 154. An internal thread 156 is providing on the inside of the circular side wall 152. The internal thread 156 matches and is intended to engage the external thread 226 on the first portion 210 of the closure 200 in order to secure the over cap 150 to the assembled container body 110 and closure 200.

The closure 200, including the first and second portions thereof, can be manufactured using any suitable production method and raw materials. However, in the preferred embodiment, the closure is a molded from a material such as high density polyethylene, polyethylene, or polypropylene. Those of skill in the art will recognize that a number of different materials are suitable for constructing the closure 200, including materials that match the material construction of the container body 110 and over cap 150 to further enhance the aesthetic qualities of the overall container 100.

The preferred embodiment of the invention has been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. An improved dispensing closure for a powder container, said powder container having a container body, the closure comprising:
a first portion connected with said container body and comprising:
a first bottom surface;
a first upwardly extending side wall, said first upwardly extending side wall further comprising a first engagement means;
at least a first dispensing outlet in said first bottom surface;
a second portion comprising:
a second bottom surface;
a second upwardly extending side wall, said second side wall further comprising a second engagement means and wherein said second engagement means cooperates with said first engagement means to rotationally engage said second portion with said first portion;
at least a second dispensing outlet in said second bottom surface; said second dispensing outlet defining an area at least as large as said first dispensing outlet; and
a tamper evident tab removably attached to said second portion and positioned at said second dispensing outlet.

2. The improved dispensing closure as set forth in claim 1, wherein said first dispensing outlet further comprises a plurality of sifting holes extending through said first bottom surface.

3. The improved dispensing closure as set forth in claim 2, further comprising a plurality of detents in an upper side of said first bottom surface, said plurality of detents corresponding in number and arrangement to said plurality of sifting holes and being laterally displaced from said plurality of sifting holes by an angle α.

4. The improved dispensing closure as set forth in claim 1, further comprising:
a guide protrusion extending from an upper side of said first bottom surface;
a guide track extending from a lower side of said second bottom surface; and
wherein said guide protrusion slidably engages with said guide track when said first and second portions are engaged with one another.

5. The improved dispensing closure as set forth in claim 2, further comprising:
a guide protrusion extending from an upper side of said first bottom surface;
a guide track extending from a lower side of said second bottom surface; and
wherein said guide protrusion slidably engages with said guide track when said first and second portions are engaged with one another wherein said guide protrusion is arranged on said upper side of said first bottom surface laterally displaced from said plurality of detents by an angle β.

6. The improved dispensing closure as set forth in claim 2, wherein an outer periphery of said second dispensing outlet corresponds to an outer periphery of said plurality of sifting holes.

7. The improved dispensing closure as set forth in claim 2, further comprising a plurality of first protrusions extending from a lower side of said second bottom surface, said plurality of first protrusions corresponding in number and arrangement to said plurality of sifting holes and being laterally displaced from said second dispensing outlet by an angle θ.

8. The improved dispensing closure as set forth in claim 5, further comprising a plurality of first protrusions extending from a lower side of said second bottom surface, said plurality of first protrusions corresponding in number and arrangement to said plurality of sifting holes and being laterally displaced from said second dispensing outlet by an angle θ and wherein said angles, α, β, and θ are about equal.

9. The improved dispensing closure as set forth in claim 8, wherein said angles, α, β, and θ are each about ninety degrees.

10. The improved dispensing closure as set forth in claim 4, wherein said guide track traverses an angle τ around said second bottom surface.

11. The improved dispensing closure as set forth in claim 8, wherein said guide track traverses an angle τ around said second bottom surface, said angle τ being about equal to angles α, β, and θ.

12. The improved dispensing closure as set forth in claim 1, further comprising container engagement means on said first portion.

13. The improved dispensing closure as set forth in claim 12, wherein said container engagement means further comprises:
a downwardly extending flange;
a first, external lip along said downwardly extending flange; and
a ridged surface connected with and oriented generally perpendicularly to said downwardly extending flange.

14. The improved dispensing closure as set forth in claim 1, wherein said first engagement means further comprises a second, external lip along at least a portion of said first upwardly extending side wall.

15. The improved dispensing closure as set forth in claim 1, wherein said first upwardly extending side wall further comprises a threaded portion thereon.

16. The improved dispensing closure as set forth in claim 14, wherein said second engagement means further comprises:
a collar, said collar having an outer wall with an inner surface; and
a first, internal lip along said inner surface of said outer wall, said first internal lip engaging said second, external lip of said first upwardly extending side wall when said first and second portions are engaged with one another.

17. The improved dispensing closure as set forth in claim 4, wherein said guide track further comprises a semi-circular depression in said lower side of said second bottom surface.

18. The improved dispensing closure as set forth in claim 2, wherein said tamper evident tab further comprises a plurality of second protrusions extended from a lower side of said tamper evident tab, said plurality of second protrusions corresponding in number and arrangement to said plurality of sifting holes.

19. The improved dispensing closure as set forth in claim 1, wherein said tamper evident tab is removably connected to an outer periphery of said second dispensing outlet and arranged generally within said second dispensing outlet.

20. The improved dispensing closure as set forth in claim 1 wherein at least a first portion of said tamper evident tab is co-planar with said second bottom surface.

21. The improved dispensing closure as set forth in claim 1, wherein said tamper evident tab further comprises a handle extension.

22. An improved dispensing closure for a powder container having a container body, comprising:
a first portion comprising:
a first bottom surface;
a first upwardly extending side wall, said first side wall further comprising a first external lip;
a downwardly extending flange and a second, external lip thereon for connecting said first portion with said container body;
a ridged surface connected with said first portion for limiting movement of said first portion relative to said container body;
at least a first dispensing outlet in said first bottom surface;
a guide protrusion on an upper side of said first bottom surface;
a second portion comprising:
a second bottom surface;
a second upwardly extending side wall, said second side wall further comprising a collar and an internal lip along a portion thereof and wherein said collar and internal lip cooperate with said first external lip of said first side wall to rotationally engage said first portion with said second portion;
at least a second dispensing outlet in said second bottom surface; said second dispensing outlet defining an area at least as large as said first dispensing outlet;
a guide track, wherein said guide protrusion and said guide protrusion cooperate to limit rotational movement of said second portion relative to said first portion; and
a tamper evident tab removably attached to said second portion and positioned in said second dispensing outlet.

23. A method of selectively closing a powder container having a container body with an opening, said method comprising the steps of:
providing a first portion of a dispensing closure having a first bottom surface, a first upwardly extending side wall, said first upwardly extending side wall further comprising a first engagement means, and at least a first dispensing outlet in said first bottom surface;
connecting said first portion of said dispensing closure to said container body to close a portion of said container body opening;
providing a second portion of said dispensing closure having a second bottom surface, a second upwardly extending side wall, said second side wall further comprising a second engagement means, at least a second dispensing outlet in said second bottom surface, said second dispensing outlet defining an area at least as large as said first dispensing outlet, and a tamper evident tab connected to said second portion at said second dispensing outlet;
connecting said second portion of said dispensing closure to said first portion thereof by engaging said second engagement means with said first engagements for rotational engagement of said second portion with said first portion;
removing said tamper evident tab;
rotating said second portion in a first direction relative to said first portion to close said container body; and
rotating said second portion in a second direction opposite said first direction relative to said first portion to open said container body.
